(19) United States
(12) Patent Application Publication
(10) Pub. No.: US 2021/0151025 A1
(43) Pub. Date: May 20, 2021

(54) APPARATUS FOR MODIFYING ACOUSTIC TRANSMISSION

(71) Applicant: The University of Manchester, Manchester, Greater Manchester (GB)

(72) Inventors: William James Parnell, Manchester (GB); William David Rowley, Manchester (GB); Ian David Abrahams, Manchester (GB); William John Lamb, Malmesbury (GB); Stephanie Ruth Voisey, Malmesbury (GB); Nicolas Etaix, Malmesbury (GB)

(21) Appl. No.: 16/625,465

(22) PCT Filed: Jun. 22, 2018
(86) PCT No.: PCT/GB2018/051751

§ 371 Date: Dec. 20, 2019

(30) Foreign Application Priority Data
Jun. 22, 2017 (GB) 1709986.2

(51) Int. Cl. G10K 11/172

(52) U.S. Cl. CPC G10K 11/172

(57) ABSTRACT

An apparatus for modifying acoustic transmission comprises an array of structures arranged along a transmission path and each structure having a major axis and a minor axis, the structures being arranged such that a minor axis of each void or structure is aligned with the transmission path.

### BACKGROUND

### Technical Field

The present disclosure relates to apparatus for modifying acoustic transmission, and to silencers comprising such apparatus.

### Description of the Related Art

In the context of acoustic transmission along ducts, reactive silencers can be employed to counteract noise at specific frequencies. Examples of such resonators include Helmholtz resonators, quarter-wavelength resonators, Herschel-Quincke tubes and expansion chambers.

A quarter-wavelength resonator comprises a closed-end side-branch for receiving part of an acoustic wave travelling within the duct. Within the side branch, the acoustic wave is reflected and rejoins the duct. The acoustic wave having a wavelength which is four times the length of the resonator rejoins the duct out of phase and thus destructively interferes with an incident acoustic wave having the same wavelength. The frequency of the acoustic wave which is targeted by the resonator thus depends on the length of the side branch; to reduce the frequency of the targeted wave, the length of the resonator is increased.

Through selection of the relevant dimensional parameters, the resonator can be tuned to target a specific frequency. To reduce transmission of a range of different frequencies of sound within a duct, it is possible to use, for example, an array of quarter-wavelength resonators of different lengths distributed along the duct. However, the inclusion of resonators along the duct inevitably increases the external diameter of the duct. To reduce transmission of lower frequency sound waves, the resonators may become prohibitively long.

### BRIEF SUMMARY

We have studied, by way of example, how to adjust the target acoustic wavelength of a quarter-wavelength resonator without changing the physical length of the side branch of the resonator. Through a combination of transformation acoustics and homogenized media theory, we have designed an apparatus for modifying acoustic transmission which, when inserted into a side branch, has the effect of making the side branch appear acoustically longer than its physical length. This can enable a reduction in transmission of relatively low frequency energy with a resonator having a relatively short length.

According to aspects of the present disclosure, there are provided apparatus as set forth in the appended claims.

In a first aspect, the present disclosure provides apparatus for modifying acoustic transmission in a transmission path, comprising an array of voids or structures arranged along the transmission path and each having a major axis and a minor axis, the voids or structures being arranged such that the minor axis of each void or structure is aligned with the transmission path.

The transmission path has a direction, which may be straight or curved. The transmission path direction is preferably located in a plane, and the array is preferably arranged such that, as measured in this plane, the voids or structures have an aspect ratio which is greater than 1. By aspect ratio, we mean the ratio of the length of the major axis, or largest diameter or dimension, to the length of the minor axis, or length of the largest dimension orthogonally crossing the major axis. For example, in this plane the voids or structures may have a cross-section which is eccentric in shape, for example elliptical.

The apparatus is preferably arranged to modify the acoustic transmission of a broad range of frequencies where the spacing between the voids or structures in the array is significantly less than the wavelength of that acoustic wave. In a preferred embodiment, each of the voids or structures is located within a respective unit cell which is preferably at least eight times smaller than the selected wavelength, more preferably in the range from eight to forty times smaller than the selected wavelength. With such an arrangement an incident wave interacts with the apparatus as if it were an effective homogeneous medium, as opposed to individual interactions with each structure or void. The apparatus provides an effective homogeneous medium through which the speed of sound is slower than through the host medium, slowing the transmission of energy. This can be seen as comparable to transmission through a longer length of host medium only. The effective homogeneous medium which is experienced by the waves has properties which are dependent on the aspect ratio, periodicity and filling fraction of the voids or structures, and the variation of properties of the array and its host medium.

The apparatus is broadband, insofar as it functions across a range of frequencies and does not rely on resonances of the array itself. Neither does it rely on the phenomenon of stop bands, which are frequency ranges in which acoustic energy cannot propagate; this is a usual application of periodic structures which operate at a wavelength of an order comparable to the spacing between the structures.

Using transformation acoustics, the effective material properties required to achieve the modified acoustic transmission have been found to be anisotropic. By using an array having voids or structures with an aspect ratio greater than one, the required variation in effective properties can be achieved. The apparatus has an effective impedance close to that of the host medium.

The voids or structures within the array preferably have the same shape, and the same size. The voids or structures may be arranged randomly. However, the voids or structures are preferably arranged in a periodic or nearly periodic distribution. For example, the voids or structures may be arranged in an array which has, when viewed in said plane, a regular or irregular polygonal or non-polygonal distribution. In one embodiment, in which the apparatus is arranged for insertion into a duct or side branch having parallel side walls in said plane, the voids or structures are arranged in an array which has a rectangular distribution in this plane. In another embodiment, the voids or structures are arranged in a single row which extends along the transmission path direction.

The array is preferably arranged such that the minor axes of the voids or structures are oriented at a common angle to the transmission path direction. The angle which the minor axes subtend to the propagation direction is chosen to control the acoustic properties of the apparatus. For example, for each void or structure the angle subtended between its minor axis and the transmission path direction may be less than 15°. In a preferred embodiment, the minor axes are parallel to the transmission path direction.

Preferably, each of the voids or structures has a periphery which is in the shape of a closed curve or a closed polygon. The polygon preferably has two-fold rotational symmetry and/or two-fold mirror symmetry. To facilitate manufacture and to allow the apparatus to be relatively easily “tuned” physically to provide the required acoustic properties, it is convenient that each of the voids or structures has a periphery which is in the shape of an ellipse.

The array may comprise a distribution of voids formed in, or encapsulated by, a host structure. The voids are distinguished from the host material by being vacuum-filled or by being filled with a material which is different from the host material. The shape of each void is defined by the shape of its three dimensional, continuous perimeter, which is in turn defined by the surrounding host material. The voids may take one of a number of three dimensional shapes, such as ellipsoid, spheroid, cuboid, or other regular or irregular three dimensional polyhedron. In a second aspect, the present disclosure provides apparatus for modifying acoustic transmission in a transmission path, comprising an array of voids arranged along the transmission path and each having a major axis and a minor axis, the voids being arranged such that the minor axis of each void is aligned with the transmission path.

Alternatively, the array may comprise a distribution of solid structures within an acoustic transmissive medium. In contrast to voids, the shape of the perimeters of the structures is defined by the structures themselves, as opposed to being defined by the surrounding medium. The structures may be in the form of pillars or columns having a length extending perpendicular to the plane containing the transmission path direction. The pillars or columns may be surrounded by air or an acoustic transmissive material. As another alternative, the array comprises a distribution of structures suspended within an acoustic transmissive material. These structures may have a similar shape to an array of voids, and so the structures may take one of a number of three dimensional shapes, such as ellipsoid, spheroid, cuboid, or other regular or irregular three-dimensional polyhedron. In a third aspect, the present disclosure provides apparatus for modifying acoustic transmission in a transmission path, comprising an array of structures arranged along the transmission path and each having a major axis and a minor axis, the structures being arranged such that the minor axis of each structure is aligned with the transmission path.

In a fourth aspect, the present disclosure provides a silencer comprising a duct or a chamber housing apparatus as aforementioned. The silencer may be in the form of one of a Helmholtz resonator, a quarter-wave resonator, an expansion chamber and a Herschel-Quincke tube.

In a fifth aspect, the present disclosure provides a system comprising a source of acoustic energy and apparatus as aforementioned for modifying transmission of acoustic waves generated by the source. As mentioned above, the apparatus may be housed within a silencer connected to a duct having a bore for receiving acoustic waves generated by the source. The acoustic waves generated by the source have a wavelength, and each of the voids or structures is located within a respective unit cell which is preferably at least eight times smaller than said wavelength, more preferably in the range from eight to forty times smaller than said wavelength.

Features described above in connection with the first aspect of the disclosure are equally applicable to any of the second to fifth aspects of the disclosure, and vice versa.

### BRIEF DESCRIPTION OF THE SEVERAL VIEWS OF THE DRAWINGS

Preferred features of the present disclosure will now be described by way of example only with reference to the accompanying drawings, in which:

FIG. 1 illustrates a quarter-wave resonator housing apparatus for modifying acoustic transmission within the resonator;

FIG. 2 illustrates schematically a system including the apparatus of FIG. 1;

FIG. 3 is a graph indicating the variation of transmission loss across two different quarter-wave resonators with the frequency of sound waves emitted from a loudspeaker;

FIG. 4 illustrates an empty quarter-wave resonator used in the generation of the graph (solid line) of FIG. 3;

FIG. 5 illustrates schematically a system including the apparatus according to an embodiment of the disclosure; and

FIG. 6 illustrates schematically a system including the apparatus according to an embodiment of the disclosure and an effective representation thereof.

### DETAILED DESCRIPTION

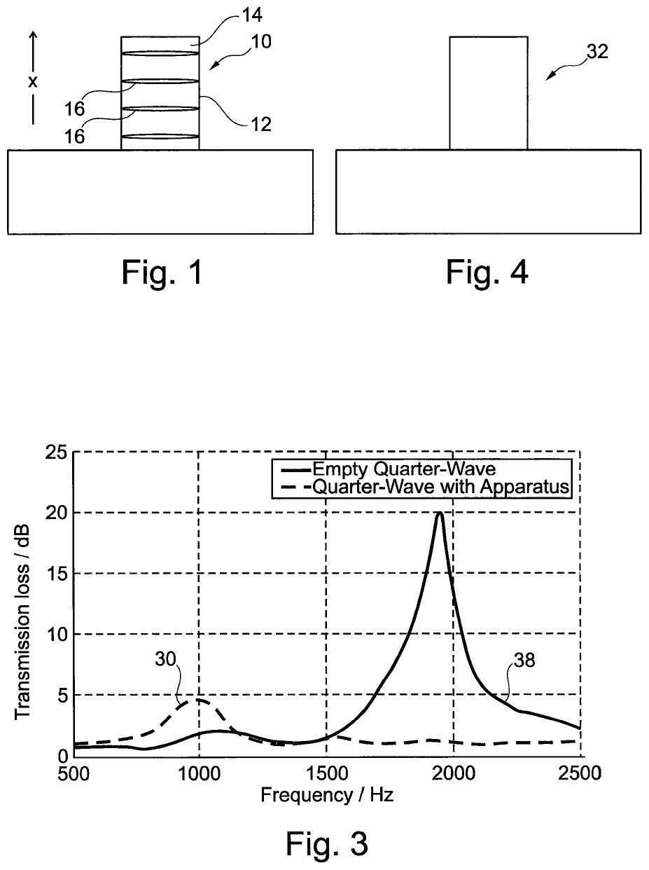

FIG. 1 illustrates an example of quarter-wave resonator 10 comprising a side branch 12 housing apparatus 14 for modifying acoustic transmission within the resonator 10. The apparatus 14 comprises an array of structures having a length extending normal to the direction X of the transmission path of a longitudinal acoustic wave through the apparatus 14. In this example, the array is in the form of a distribution of pillars 16 which are surrounded by air, but the pillars 16 may be surrounded by acoustic foam or other acoustic transmissive material. The pillars 16 are upstanding from, preferably connected to, and more preferably integral with, an internal surface of the side branch 12 of the resonator 10. As an alternative to pillars, the array may comprise voids or slots formed in, or encapsulated by, a host structure, such as acoustic foam or other acoustic transmissive material.

Each of the pillars 16 has the same length, and the same cross-section in a plane containing the transmission path direction X. Each of the pillars 16 has, as measured in this plane, an aspect ratio which is greater than 1. With an aspect ratio of 2, for example, the cross-sectional shape of the pillars may be in the form of ellipses, rectangles or other polygons, whereas with an aspect ratio of 20 or more, for example, the cross-sectional shape of the pillars may be in the form of relatively narrow fins, slats or strips of material. In this illustrated example, each of the pillars 16 has an elliptical cross-section in the plane containing the transmission path direction X.

The cross-section in this plane has a major axis and a minor axis. In this illustrated example, the distribution of pillars 16 is arranged such that the minor axis of each pillar 16 is aligned to the transmission path direction X. In this illustrated example, the transmission path direction is straight, and so the minor axes of the pillars are parallel. Alternatively, the side branch 12, and so the transmission path direction, may be curved, and so the minor axes of adjacent pillars, or of adjacent rows of pillars, may be mutually inclined so that the minor axis of each pillar is parallel to the transmission path direction X as it intersects that pillar. The pillars 16 may be arranged in a periodic or aperiodic distribution. In this illustrated example, each of the pillars 16 is arranged centrally within a respective unit cell, with the unit cells being arranged within a column.

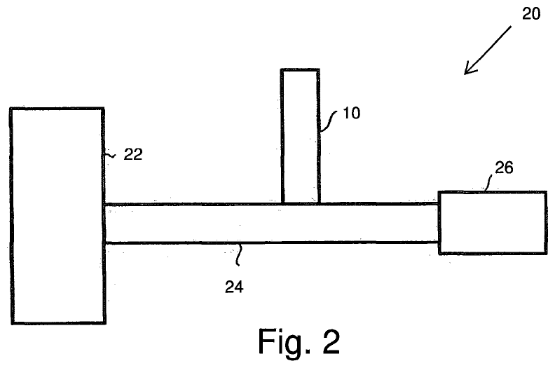

FIG. 2 illustrates a system 20 which includes the resonator 10. The system includes a source 22 of acoustic energy and a duct 24 which is in fluid communication with the source 22 and so is able to receive sound waves generated by the source 22. In this example, the duct 24 has a constant cross-section along its length. The resonator 10 is arranged at a right angle to the duct 24, although this is not essential.

FIG. 3 illustrates the results of tests conducted using an embodiment of system 20. In this embodiment, the source 22 of acoustic energy is provided by a loudspeaker from which a chirp is emitted into one end of a duct 24 having a 30×30 mm cross-section. An anechoic termination 26 is positioned at the opposite end of the duct 24. A quarter-wave resonator 10 is connected between the source 22 and the termination. The resonator 10 includes a side branch 12 having a length of 40 mm and a rectangular cross-section in the plane of the transmission path direction of 26.7×16 mm². The side branch 12 comprises an array of pillars 16 arranged parallel to the side walls of the side branch 12, and extending between the upper and lower walls of the side branch 12. Within the side branch 12, the pillars 16 are arranged in a 1×4 rectangular array which extends along the transmission path direction X. Each pillar 16 has an elliptical cross-section with an aspect ratio of 25, with the minor axes of the pillars 16 being arranged parallel to the transmission path direction X.

During the tests, chirps having a frequency in the range from 500 to 3000 Hz were emitted from the loudspeaker. The transmission loss across the resonator 10 was measured as each chirp was emitted from the loudspeaker. The variation in the transmission loss with the frequency of the emitted chirp is indicated at trace 30 in FIG. 3. Separate tests were also conducted using a different resonator 32, illustrated in FIG. 4, which did not include an array of structures within the side branch. Resonator 32 had the same length and cross-section as resonator 10. The variation in the transmission loss with the frequency of the emitted chirp when resonator 32 was used is indicated at trace 38 in FIG. 3.

Using the resonator 10, maximum transmission losses of around 5 dB were achieved when a chirp of frequency around 960 Hz was emitted from the loudspeaker. Using the resonator 32, a maximum transmission loss of around 20 dB was achieved when a chirp of frequency around 1940 Hz was emitted from the loudspeaker. Therefore, in the same size package, resonator 10 with the inserted apparatus is able to reduce transmission loss at a frequency with over twice the wavelength than that achieved with resonator 32 without the apparatus. Therefore, resonator 32 acts conventionally as a quarter-wave resonator (wavelength is four times the length of the resonator), but resonator 10, with the apparatus, acts effectively as an eighth-wave resonator (wavelength is eight times the length of the resonator), but in the same size package.

In vacant resonators, a plane acoustic wave of wavelength 4L, propagating along the duct, is attenuated, in some cases almost completely, by a side-branch of length L, due to destructive interference. This occurs because the acoustic wave propagates up the side branch, is reflected and is then in anti-phase with the incoming wave when it re-enters the duct. In order to increase effectiveness at lower frequencies the side branch length is often made longer in known, such as empty side-branch, resonators. However, the addition of an array 14 according to embodiments of the present disclosure into the side-branch as depicted in FIGS. 1-4, ensures that the side-branch can be made shorter than for a known resonator in the following way.

Appropriately selecting a size, aspect ratio, and material properties of the array 14 creates an effective medium, which reduces a speed of sound, such as halves the speed of sound, in the side branch whilst simultaneously ensuring a good impedance-match to air. Reducing, such as halving, the speed of sound in the side-branch means that the side-branch is reduced in length, such as being half the length, than it would otherwise need to be in order to create the required anti-phase when the wave returns to the duct. Impedance matching ensures that the acoustic energy from the incoming wave in the duct can enter the side-branch. Both effects (reducing the speed of sound and impedance matching) are associated with an effectiveness of embodiments of the disclosure.

Using the array 14 in this manner within a side branch means that a wave of a given wave length (or frequency) can be attenuated with a side branch that is reduced in size. Or, alternatively if an empty side branch of length L is replaced with one that contains the array 14 according to an embodiment of the present disclosure, it will attenuate waves of, for example, wavelength 8L rather than 4L.

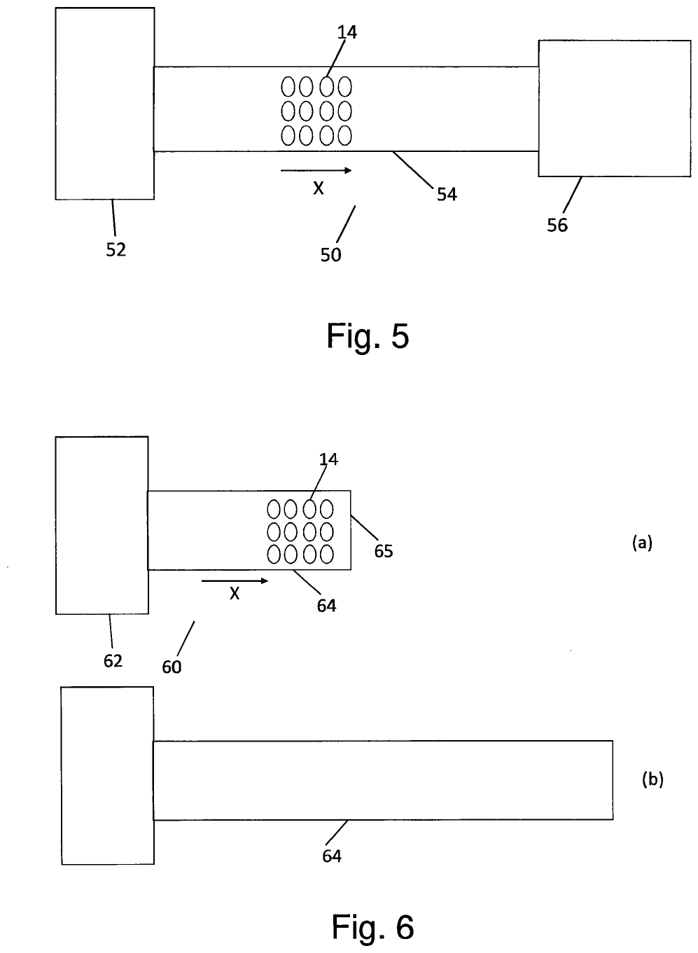

FIGS. 5 and 6 illustrate apparatus according to an embodiment of the disclosure inserted into a duct.

FIG. 5 illustrates a system 50 which includes an apparatus 14 for modifying acoustic transmission according to an embodiment of the present disclosure. The system 50 includes a source 52 of acoustic energy and a duct 54 which is in fluid communication with the source 52 and so is able to receive sound waves generated by the source 52. In this example, the duct 54 has a constant cross-section along its length. The apparatus 14 is located within the duct 54 as shown. An anechoic termination 56 is positioned at the opposite end of the duct 54. In the configuration shown in FIG. 5, the array of structures 14 is placed in an otherwise vacant duct 54 and acoustic energy passes through the duct 54, which in the illustrated example is from left to right.

As described above, the apparatus 14 comprises an array of structures having a major axis extending generally normal to the direction X of the transmission path of a longitudinal acoustic wave through the apparatus 14. The direction X of the transmission path of the longitudinal acoustic wave is parallel to a longitudinal axis of the duct 54.

Placing the array of structures 14 as described above, which may have an impedance close to that of air, in the duct 54 itself as illustrated in FIG. 5 means that the duct 54 appears to be acoustically longer than an empty or vacant duct of the same physical length. This is due to the reduction of the speed of sound in the duct 54 associated with the presence of the array of structures 14. By closer impedance matching, energy is better transmitted into the array of structures 14 without strong reflection.

A further embodiment is illustrated in FIGS. 6(a) and 6(b). FIG. 6(a) illustrates a system 60 which includes an apparatus 14 for modifying acoustic transmission according to an embodiment of the present disclosure. The system 60 includes a source 62 of acoustic energy and a duct 64 which is in fluid communication with the source 62 and so is able to receive sound waves generated by the source 62. In this example, the duct 64 has a constant cross-section along its length. The apparatus 14 is located within the duct 64 as shown. The apparatus 14 is proximal to an end 65 of the duct 64. The end 65 may be a rigid end 65 which is located at an opposing side of the apparatus 14 to the source 62.

If the duct 64 is investigated acoustically with the source 62, acoustic energy entering the array of structures 14 is thereby slowed by the array of structures 14. The acoustic energy is then reflected from the duct end 65 and returns to the source 62, or to a receiver region in a test situation.

FIG. 6(b) illustrates an equivalent empty or vacant duct representation of the system 60 shown in FIG. 6(a). A time of flight experiment would predict that the duct end 65 is located at a position that is further away from the source 62 than its true location. That is, introducing the array of structures 14 into the duct 64 has an effect of making the duct appear longer than its true length.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus for modifying acoustic transmission in a transmission path, comprising an array of structures arranged along the transmission path, each structure having a major axis and a minor axis and being arranged such that the minor axis of each structure is generally aligned with the transmission path.

2. The apparatus according to claim 1, wherein the array is surrounded by air or an acoustic transmissive material.

3. The apparatus according to claim 2, wherein the structures are arranged in a periodic or aperiodic distribution.

4. The apparatus according to claim 1, wherein the transmission path has a direction, and each of the structures has a major axis and a minor axis in a plane containing the transmission path direction, and wherein the minor axis is aligned parallel to the transmission path direction.

5. The apparatus according to claim 1, wherein each of the structures has a periphery which is in the shape of a closed curve or a closed polygon.

6. The apparatus according to claim 5, wherein each of the structures has a periphery which is in the shape of an ellipse.

7. The apparatus according to claim 4, wherein the array comprises a distribution of pillars having a length extending perpendicular to the plane.

8. The apparatus according to claim 1, wherein the array comprises a distribution of ellipsoids, spheroids, cuboids, or regular or irregular three-dimensional polyhedrons.

9. A side branch housing an apparatus according to claim 1.

10. A duct comprising an apparatus according to claim 1 arranged within the duct.

11. The apparatus according to claim 1, wherein each structure is generally aligned with the transmission path up to an angle of 15°.

12. A system comprising a source of acoustic energy and apparatus according to claim 1 for modifying transmission of acoustic waves generated by the source.

13. The system according to claim 12, wherein the acoustic waves generated by the source have a wavelength, and wherein each of the structures is located within a respective unit cell which is, in the direction of the transmission path, at least eight times smaller than the wavelength.

14. The system according to claim 13, wherein each of the structures is located within a respective unit cell which is, in the direction of the transmission path, in the range from eight to forty times smaller than the wavelength.

15. The system according to claim 12, wherein the apparatus is arranged within a side branch of a duct in fluid communication with the source.

16. The system according to claim 12, wherein the apparatus is arranged within a duct.

17. The system according to claim 12, wherein each structure is generally aligned with the transmission path up to an angle of 15°.
